(19) United States
(12) Patent Application Publication
(10) Pub. No.: US 2011/0236677 A1
(43) Pub. Date: Sep. 29, 2011

(54) GALVANIZED STEEL SHEET AND METHOD FOR PRODUCING THE SAME

(75) Inventors: Yoichi Makimizu, Fukuyama (JP); Hiroshi Kajiyama, Chiba (JP); Sakae Fujita, Chiba (JP); Naoto Yoshimi, Fukuyama (JP); Masahiko Tada, Chiba (JP); Shinji Ootsuka, Fukuyama (JP); Hiroyuki Masuoka, Chiba (JP); Katsuya Hoshino, Fukuyama (JP)

(73) Assignee: JFE STEEL CORPORATION, Tokyo (JP)

(21) Appl. No.: 13/132,225

(22) PCT Filed: Apr. 22, 2009
(86) PCT No.: PCT/JP2009/058427

§ 371 Date: Jun. 1, 2011

(30) Foreign Application Priority Data
Dec. 16, 2008 (JP) 2008-319132

(51) Int. Cl. B32B 15/18; B05D 3/00; B05D 7/14; B32B 15/04

(52) U.S. Cl. 428/336; 427/372.2

(57) ABSTRACT

A method for producing a galvanized steel sheet includes contacting a steel sheet with a zinc-containing aqueous solution having a zinc ion concentration of 1 to 100 g/l, contacting the steel sheet with an aqueous solution with a pH of 6 to 14, washing the steel sheet with water, and then drying the steel sheet. An example of the zinc-containing aqueous solution is a solution containing zinc sulfate. According to the method, an oxide layer which has an average thickness of 10 nm or more and which principally contains zinc is formed on the steel sheet and the galvanized steel sheet can be stably produced at high speed in a reduced space so as to have excellent press formability.

### TECHNICAL FIELD

The present invention relates to a method for stably producing a galvanized steel sheet having low sliding resistance and excellent press formability during press molding and also relates to a galvanized steel sheet.

### BACKGROUND ART

Galvanized steel sheets are widely used for various applications such as automotive bodies. For such applications, the galvanized steel sheets are press-molded for use. The galvanized steel sheets, however, have a disadvantage that the galvanized steel sheets are inferior in press formability to cold-rolled steel sheets. This is because the sliding resistance of the galvanized steel sheets to press molds is greater than that of the cold-rolled steel sheets. That is, the galvanized steel sheets have portions with high sliding resistance to press molds and beads and therefore are unlikely to be provided in the press molds; hence, the galvanized steel sheets are likely to be broken.

Galvannealed steel sheets produced through hot-dip galvanizing and then alloying are more excellent in weldability and coatability as compared with other galvanized steel sheets and are widely used for automotive bodies.

A galvannealed steel sheet is one obtained as follows: a steel sheet is galvanized and is then heat-treated such that an alloying reaction occurs due to the interdiffusion of Fe in the steel sheet and Zn in a plating layer to create an Fe—Zn alloy phase. The Fe—Zn alloy phase is usually a coating consisting of a Γ phase, a δ₁ phase, and ζ phase. Hardness and melting point tend to decrease with a reduction in Fe concentration, that is, in the order of the Γ phase, the δ₁ phase, and the ζ phase. Therefore, high-Fe concentration coatings are useful in view of slidability because the coatings have high hardness and a high melting point and are unlikely to be adhesive. Since press formability is one of important properties of the galvannealed steel sheet, the galvannealed steel sheet is produced so as to include a coating with a slightly increased Fe concentration.

However, the high-Fe concentration coatings have a problem that Γ phases which are hard and brittle are likely to be formed at plating-steel sheet interfaces to cause a phenomenon in which peeling occurs at the interfaces, that is, so called powdering, during machining.

Patent Documents 1 and 2 disclose techniques for solving the problem. In the techniques, a galvanized steel sheet is improved in weldability and workability in such a manner that an oxide film made of ZnO is formed on the galvanized steel sheet by electrolysis, dipping, coating oxidation, or heating.

However, the application of the techniques disclosed in the Patent Documents 1 and 2 to the galvannealed steel sheet is not effective in achieving an improvement in press formability because the galvannealed steel sheet has low surface reactivity and large surface irregularities because of the presence of Al oxides. Since the galvannealed steel sheet has low surface reactivity, it is difficult to form a desired coating on the galvannealed steel sheet by electrolysis, dipping, coating oxidation, or heating and a portion with low reactivity, that is, a portion containing a large amount of the Al oxides, is reduced in thickness. Since the surface irregularities are large, surface protrusions are brought into direct contact with a press mold during press molding and contacts between the press mold and thin portions of the surface protrusions have high sliding resistance; hence, a sufficient improvement in press formability cannot be achieved.

Patent Document 3 discloses a technique in which a steel sheet is galvanized by hot dipping, alloyed by heating, temper-tolled, contacted with an acidic solution with pH buffering action, held for one to 30 seconds, and then washed with water, whereby an oxide layer is formed on a plating surface layer.

Patent Document 4 discloses a method for forming an oxide layer on a flat surface portion of an unalloyed hot-dip galvanized steel sheet. In the method, the hot-dip galvanized steel sheet is temper-rolled, contacted with an acidic solution with pH buffering action, held for a predetermined time in such a state that a film of the acidic solution is disposed on the steel sheet, washed with water, and then dried.

A method disclosed in Patent Document 5 is effective in uniformly forming an oxide layer on an electrogalvanized steel sheet. In this method, the electrogalvanized steel sheet is contacted with an acidic solution with pH buffering action or an acidic electrogalvanizing bath, held for a predetermined time, washed with water, and then dried.

Patent Document 1: Japanese Unexamined Patent Application Publication No. 53-60332

Patent Document 2: Japanese Unexamined Patent Application Publication No. 2-190483

Patent Document 3: Japanese Unexamined Patent Application Publication No. 2003-306781

Patent Document 4: Japanese Unexamined Patent Application Publication No. 2004-3004

Patent Document 5: Japanese Unexamined Patent Application Publication No. 2005-248262

In the case of using the techniques disclosed in Patent Documents 3 to 5, good press formability can be achieved under conventional production conditions. However, it has become clear that good press formability cannot be achieved in some cases because the holding time of steel sheets contacted with acidic solutions cannot be sufficiently secured under recent high-speed conditions and therefore formed oxide layers are thin.

In order to solve such a problem, it is effective to increase the distance from the contact with an acidic solution to water washing. However, this needs to secure a space therebetween, leading to spatial restriction.

In view of the foregoing circumstances, the present invention has an object to provide a method capable of stably producing a galvanized steel sheet having excellent press formability in a reduced space under high-speed conditions and an object to provide a galvanized steel sheet having excellent press formability.

### DISCLOSURE OF INVENTION

The inventors have made intensive investigations to solve the above problems. As a result, the inventors have obtained findings below.

It has turned out from that in the techniques disclosed in Patent Documents 3 to 5, zinc ions dissolved from zinc plating are used to produce zinc oxide on surfaces and therefore the time taken to dissolve the zinc ions therefrom elongates the time taken to form the oxide films. Thus, the inventors have considered that if a solution used to form an oxide film contains zinc ions, the time taken to dissolve the zinc ions is not needed and therefore the time taken to form the oxide film can be reduced. However, no oxide film has been sufficiently formed from a solution containing zinc ions. This is probably because although environments suitable for producing zinc oxides are created in the techniques disclosed in Patent Documents 3 to 5 since hydrogen ions are reduced simultaneously with the dissolution of zinc and therefore the pH in the vicinity of a surface increases, the use of the zinc ion-containing solution is not enough to increase the pH in the vicinity of a surface and therefore any environment suitable for producing zinc oxides is not created. Therefore, the inventors have conceived that a galvanized steel sheet is contacted with an aqueous solution containing zinc and is further contacted with a weak alkali solution, whereby the pH in the vicinity of a surface therefore is increased.

The present invention is based on the above finding. The scope of the present invention is as described below.

(1) A method for producing a galvanized steel sheet obtained by forming an oxide layer on a steel sheet includes contacting the steel sheet with a zinc-containing aqueous solution having a zinc ion concentration of 1 to 100 g/l, contacting the steel sheet with an aqueous solution with a pH of 6 to 14, washing the steel sheet with water, and then drying the steel sheet.

(2) In the galvanized steel sheet-producing method specified in Item (1), the zinc ion concentration is within a range from 5 to 100 g/l and the aqueous solution has a pH of 7 to 13.

(3) In the galvanized steel sheet-producing method specified in Item (1) or (2), the zinc-containing aqueous solution has a pH of 1 to 6.

(4) A galvanized steel sheet produced by the galvanized steel sheet-producing method specified in any one of Items (1) to (3) includes an oxide layer which principally contains zinc as a metal component, which is disposed on a steel sheet, and which has an average thickness of 10 nm or more.

The term “galvanized steel sheet” as used herein refers to a plated steel sheet having a coating which is made of zinc and which is disposed thereon and includes a hot-dip galvanized steel sheet (hereinafter simply referred to as a GI steel sheet); a galvannealed steel sheet (hereinafter simply referred to as a GA steel sheet); an electrogalvanized steel sheet (hereinafter simply referred to as an EG steel sheet); a zinc-deposited steel sheet; a zinc alloy-plated steel sheet containing an alloy element such as Fe, Al, Ni, Mg, or Co; and the like.

### BRIEF DESCRIPTION OF DRAWINGS

FIG. 1 is a schematic front view of a coefficient-of-friction tester.

FIG. 2 is a schematic perspective view showing the shape and size of a bead shown in FIG. 1.

### BEST MODES FOR CARRYING OUT THE INVENTION

According to the present invention, a galvanized steel sheet having excellent press formability and low sliding resistance during press molding can be produced in a reduced space under high-speed conditions.

In the course of producing a GA steel sheet, a steel sheet is galvanized by hot dipping and is then alloyed by heating. The GA steel sheet has surface irregularities due to the difference in reactivity between steel sheet-plating interfaces during alloying. The alloyed steel sheet is usually temper-rolled for the purpose of material achievement. A plating surface is smoothed by the contact with rollers during temper-rolling and the irregularities are reduced. Thus, the force necessary for a mold to crush plating surface protrusions is reduced during press molding and therefore sliding properties can be improved.

Since a flat surface portion of the GA steel sheet is brought into direct contact with the mold during press molding, the presence of a hard refractory substance capable of preventing the adhesion to the mold is important in improving slidability. In this viewpoint, the presence of an oxide layer on a surface layer is effective in improving slidability because the oxide layer prevents the adhesion to the mold.

Since surface oxides are worn or are scraped during actual press molding, the presence of a sufficiently thick oxide layer is necessary when the contact area between a mold and a workpiece is large. Although a plating surface has an oxide layer formed by heating during alloying, most of the oxide layer is broken during temper rolling because of the contact with rollers and therefore a fresh surface is exposed. Hence, in order to achieve good slidability, a thick oxide layer needs to be formed prior to temper rolling. Even if such a thick oxide layer is formed prior to temper rolling in consideration of this, the breakage of the oxide layer cannot be avoided during temper rolling and therefore oxide layers are nonuniformly present on flat portions. Hence, good slidability cannot be stably achieved.

Good slidability can be stably achieved by forming a uniform oxide layer on the temper-rolled GA steel sheet, particularly on a plating surface flat portion.

The following technique is effective in uniformly forming a oxide layer on a zinc plating: a technique in which a galvanized steel sheet is contacted with an acidic solution with pH buffering action, held for a predetermined time in such a state that a film of the acidic solution is disposed on the steel sheet, washed with water, and then dried. However, the formed oxide layer is thin because the time for which the steel sheet is held subsequently to the contact with the acidic solution is not sufficiently secured under recent high-speed conditions as described above; hence, good press formability cannot be achieved in some cases. It is effective in solving this problem to increase the distance from the contact with the acidic solution to water washing. However, this needs to secure a space therebetween, leading to spatial restriction.

In the present invention, it has been invented that a galvanized steel sheet is contacted with an aqueous solution containing zinc ions and is further contacted with a weak alkali aqueous solution such that an increase in pH is caused. In the present invention, it is an important requirement and feature that the galvanized steel sheet is contacted with the zinc ion-containing aqueous solution and is further contacted with the weak alkali aqueous solution. This allows an oxide layer sufficient to secure good press formability to be formed in a reduced space without suffering from spatial restriction.

A mechanism for forming the oxide layer is not clear but is probably as described below. Since the galvanized steel sheet is contacted with the zinc ion-containing aqueous solution and is then contacted with the weak alkali aqueous solution in such a state that the steel sheet is covered with the zinc ion-containing aqueous solution, the pH of the zinc ion-containing aqueous solution on the steel sheet is increased to a pH level where oxides (hydroxides) are stable. This probably results in the formation of the oxide layer, which is stable, on the galvanized steel sheet.

In the present invention, the oxide layer is formed on the galvanized steel sheet in such a manner that the steel sheet is contacted with the zinc-containing aqueous solution, contacted with the weak alkali aqueous solution, that is, an aqueous solution with a pH of 6 to 14, washed with water, and then dried.

In the present invention, the weak alkali aqueous solution has a pH of 6 to 14. Zinc is an amphoteric metal and therefore is soluble in extremely low and high pH solutions. Thus, in order to form the oxide layer, the aqueous solution on the galvanized steel sheet needs to be rendered alkaline. The pH thereof is preferably 7 to 13 and more preferably 9 to 11.

The concentration of zinc in the aqueous solution is within a range from 1 to 100 g/l in the form of zinc ions. When the concentration of the zinc ions is less than 1 g/l, a sufficient amount of zinc is not supplied and therefore the oxide layer is unlikely to be formed. When the concentration thereof is greater than 100 g/l, the concentration of sulfuric acid in the oxide layer is high and therefore it is concerned that the oxide layer is dissolved in a subsequent chemical conversion step to contaminate a conversion solution. The concentration is preferably within a range from 5 to 100 g/l.

In order to form the oxide layer from a stable zinc compound, the zinc ions are preferably used in the form of a sulfate. In the case of using the sulfate, there is probably an advantage that sulfate ions are captured in the oxide layer to stabilize the oxide layer.

The pH of the zinc-containing aqueous solution is not particularly limited and is preferably 1 to 6. When the pH thereof is greater than 6, the zinc ions form precipitates in the aqueous solution (the formation of a hydroxide) and are not provided on the steel sheet in the form of an oxide. When the pH thereof is less than 1, the dissolution of zinc is promoted; hence, the mass per unit area of plating is reduced and a plating film has cracks and therefore is likely to be stripped off during machining. When the pH thereof is high within the range of 1 to 6, the pH thereof quickly increases to a level where oxides are stable upon the contact with the weak alkali aqueous solution. This is advantageous in forming the oxides. Therefore, the pH thereof is preferably within the range of 4 to 6.

The solution disclosed in Patent Document 3 is characterized by being acidic and by having a pH buffering action. However, the zinc ion-containing aqueous solution is used herein and therefore the oxide layer can be sufficiently formed even if Zn is not sufficiently dissolved by reducing the pH of the aqueous solution. It is advantageous in forming the oxides that the pH thereof quickly increases upon the contact with the weak alkali aqueous solution. Therefore, any pH buffering action is not necessarily essential.

In the present invention, the oxide layer, which has excellent slidability, can be stably formed when an aqueous solution contacted with the steel sheet contains zinc. Therefore, even if impurities such as other metal ions and inorganic compounds are accidentally or deliberately contained in the aqueous solution, advantages of the present invention are not reduced. N, P, B, Cl, Na, Mn, Ca, Mg, Ba, Sr, and Si can be used as far as advantages of the present invention are not reduced even if these elements are captured in the oxide layer.

The oxide layer is formed on the galvanized steel sheet as described above. The oxide layer contains zinc, which is an essential component, and has a thickness of 10 nm or more.

The term “oxide layer” as used herein refers to a layer made of an oxide and/or hydroxide principally containing zinc, which is a metal component. The oxide layer, which principally contains such a component as zinc, needs to have an average thickness of 10 nm or more. When the thickness of the oxide layer less than 10 nm, an effect of reducing slidability is insufficient. When the thickness of the oxide layer, which contains such an essential component as Zn, is greater than 100 nm, a coating is broken during pressing to cause an increase in slidability and weldability is likely to be reduced. This is not preferred.

A process for contacting the galvanized steel sheet with the zinc-containing aqueous solution is not particularly limited. Examples of such a process include a process for dipping a plated steel sheet in an aqueous solution, a process for spraying an aqueous solution onto a plated steel sheet, a process for applying an aqueous solution to a plated steel sheet with a coating roller, and the like. The aqueous solution is preferably finally present on the steel sheet in the form of a thin liquid film. This is because when the amount of the aqueous solution present on the steel sheet is large, the pH of a plating surface is unlikely to be uniformly and quickly increased by alkali treatment in the next step. In this viewpoint, it is preferable and effective that the amount of an acidic solution film formed on a steel sheet is adjusted to 50 g/m² or less. The amount of the solution film can be adjusted by roll drawing, air wiping, or the like.

Examples of the galvanized steel sheet according to the present invention include those produced by various methods such as a hot-dip plating method, an electroplating method, a vapor deposition plating method, and a spraying method. Examples of a plating composition include pure Zn, Zn—Fe, Zn—Al, Zn—Ni, and Zn—Mg. However, in an embodiment of the present invention, the type of plating is not limited because the dissolution of Zn occurs in the galvanized steel sheet, which principally contains Zn, and the oxide layer can be formed.

### EXAMPLES

The present invention is further described below in detail with reference to examples.

Plating films having a mass per unit area of 45 g/m² and an Al concentration of 0.20 mass percent were formed on cold-rolled steel sheets with a thickness of 0.8 mm by hot dip galvanizing and the cold-rolled steel sheets were then temper-rolled, whereby GI steel sheets were prepared. Plating films having a mass per unit area of 45 g/m², an Fe concentration of ten mass percent, and an Al concentration of 0.20 mass percent were formed on cold-rolled steel sheets with a thickness of 0.8 mm by an ordinary galvannealing method and the cold-rolled steel sheets were then temper-rolled, whereby GA steel sheets were prepared. EG steel sheets including plating films having a mass per unit area of 30 g/m² were prepared, the plating films being formed on cold-rolled steel sheets with a thickness of 0.8 mm by an ordinary electrogalvanizing method.

The GI steel sheets, GA steel sheets, and EG steel sheets obtained as described above were dipped in zinc sulfate solutions with various concentrations shown in Table 1. After being taken out of the zinc sulfate solutions, the steel sheets were dipped in aqueous sodium hydroxide solutions adjusted in pH or the aqueous sodium hydroxide solutions were sprayed onto the steel sheets. The time taken to dip the steel sheets in the aqueous sodium hydroxide solutions or taken to spray the aqueous sodium hydroxide solutions onto the steel sheets was one second. The steel sheets were washed with water within one second after dipping or spraying was finished. Before being treated with the aqueous sodium hydroxide solutions, the steel sheets were tested in such a manner that the zinc sulfate solutions remaining thereon were wiped with rubber rollers.

For comparison, some of the steel sheets were subjected to a test in which dipping in a zinc-free solution and treatment with sodium hydroxide were performed, a test in which treatment with the aqueous sodium hydroxide solutions was not performed, a test in which dipping was not performed after temper rolling, or a test in which the pH of a zinc ion-containing aqueous solution was adjusted with sulfuric acid.

The following test was performed as a conventional technique: a test in which the steel sheets were dipped in a 50° C. aqueous solution which contained 30 g/l sodium acetate and which had a pH of 1.5 was performed, the amount of the aqueous solution remaining thereon was adjusted to 10 g/m² after dipping was finished, and the steel sheets were held for one to 30 seconds.

For the steel sheets prepared as described above, oxide layers of tempered portions and untempered portions of plating surface layers were measured for thickness and also measured for coefficient of friction for the purpose of simply evaluating press formability. Measurement methods were as described below.

(1) Press Formability Evaluation Test (Coefficient-of-Friction Measurement Test)

For the evaluation of press formability, each test piece was measured for coefficient of friction as described below.

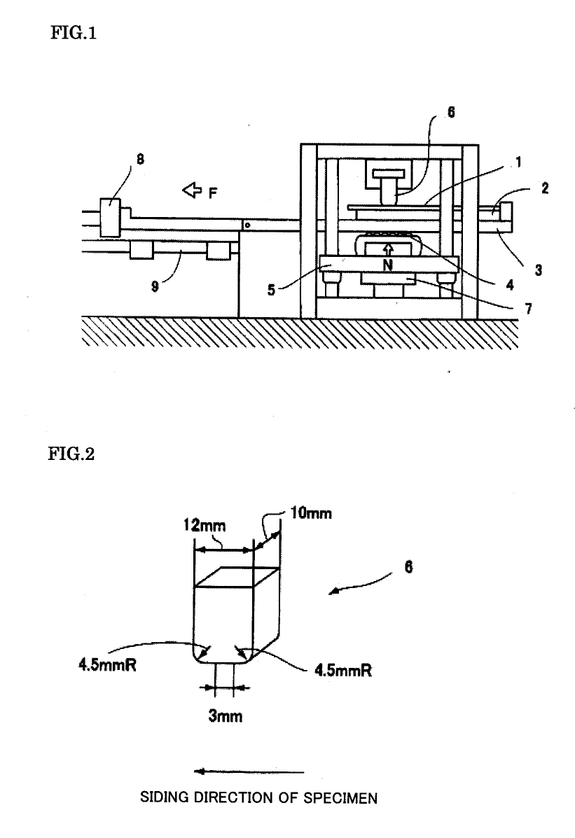

FIG. 1 is a schematic front view of a coefficient-of-friction tester. As shown in this figure, a coefficient-of-friction measurement specimen 1 taken from the test piece is fixed on a stage 2 and the stage 2 is fixed on the upper surface of a sliding table 3 which is horizontally movable. The lower surface of the sliding table 3 overlies a sliding table support 5 which includes rollers 4 in contact with the lower surface thereof and which is vertically movable. The sliding table support 5 is attached to a first load cell 7 for measuring the pressing load N applied to the coefficient-of-friction measurement specimen 1 from a bead 6 by raising the sliding table support 5. The sliding table 3 has an end portion attached to a second load cell 8 for measuring the sliding resistance force F required to horizontally move the sliding table 3 along a rail 9 in such a state that the pressing load is applied thereto. The specimen 1 was coated with lubricating oil, that is, washing oil, PRETON R352L, available from Sugimura Chemical Industrial Co., Ltd. and was then tested.

FIG. 2 is a schematic perspective view showing the shape and size of the bead used. The bead 6 slides on the specimen 1 in such a state that the lower surface of the bead 6 is pressed against the specimen 1. The bead 6 has a width of 10 mm and a length of 12 mm in the sliding direction of the specimen and includes lower end portions, spaced in the sliding direction thereof, having curved surfaces with a curvature of 4.5 mm R as shown in FIG. 2. The bead lower surface, against which the specimen is pressed, has a flat area having a width of 10 mm and a length of 3 mm in the sliding direction thereof. A coefficient-of-friction measurement test was performed under two conditions below.

(Condition 1)

The bead shown in FIG. 2 was used, the pressing load N was 400 kgf, and the drawing rate of the specimen (the horizontal movement speed of the sliding table 3) was 100 cm/min.

(Condition 2)

The bead shown in FIG. 2 was used, the pressing load N was 400 kgf, and the drawing rate of the specimen (the horizontal movement speed of the sliding table 3) was 20 cm/min.

The coefficient of friction between the test piece and the bead was calculated from the equation μ=F/N.

(2) Measurement of Thickness of Oxide Layer (Oxide Layer Thickness)

An Si wafer having an SiO₂ film, formed by thermal oxidation, having a thickness of 96 nm was used as a reference and an O·Kα x-ray was measured with an X-ray fluorescence spectrometer, whereby the average thickness of the oxide layer was determined in terms of SiO₂. The analysis area was 30 mm φ.

Test results obtained as described above are shown in Table 1.

TABLE 1

| | | | | | | | | Outer | Coefficient of | | |
|---|---|---|---|---|---|---|---|---|---|---|---|
| | | Treatment solutions | | | Holding time | NaOH solutions | | layer | friction | | |
| | Plating | Componenets | | Roll | after dipping | | Contact | thickness | Condition | Condition | |
| No. | type | concentration | pH | drawing | (second) | pH | processes | (nm) | 1 | 2 | Remarks |
| 1 | GA | Not used | | — | — | — | — | 8 | 0.180 | 0.223 | Comparative Example |
| 2 | | Sodium | 1.5 | Performed | 1 | — | — | 13 | 0.173 | 0.220 | Comparative Example |
| 3 | | acetate | | Performed | 2 | — | — | 16 | 0.164 | 0.217 | Comparative Example |
| 4 | | (30 g/L) | | Performed | 5 | — | — | 20 | 0.141 | 0.186 | Comparative Example |
| 5 | | | | Performed | 10 | — | — | 26 | 0.134 | 0.173 | Comparative Example |
| 6 | | | | Performed | 30 | — | — | 31 | 0.129 | 0.167 | Comparative Example |
| 7 | | Sodium sulfate | 5.8 | — | — | — | — | 9 | 0.182 | 0.225 | Comparative Example |
| 8 | | (10 g/L) | | — | — | 10 | Dipping | 9 | 0.183 | 0.224 | Comparative Example |
| 9 | | | | — | — | | Spraying | 9 | 0.180 | 0.222 | Comparative Example |
| 10 | | Zinc sulfate | 5.7 | — | — | | Dipping | 17 | 0.158 | 0.197 | Example of the invention |
| 11 | | (zinc: 1 g/L) | | — | — | | Spraying | 18 | 0.151 | 0.201 | Example of the invention |
| 12 | | Zinc sulfate | 5.5 | — | — | | Dipping | 21 | 0.136 | 0.168 | Example of the invention |
| 13 | | (zinc: 5 g/L) | | — | — | | Spraying | 22 | 0.137 | 0.173 | Example of the invention |
| 14 | | Zinc sulfate | 5.0 | — | — | — | — | 8 | 0.171 | 0.218 | Comparative Example |
| 15 | | (zinc: 50 g/L) | | — | — | 6 | Dipping | 16 | 0.165 | 0.201 | Example of the invention |
| 16 | | | | — | — | | Spraying | 19 | 0.150 | 0.192 | Example of the invention |
| 17 | | | | — | — | 7 | Dipping | 20 | 0.136 | 0.175 | Example of the invention |
| 18 | | | | — | — | | Spraying | 27 | 0.128 | 0.166 | Example of the invention |
| 19 | | | | — | — | 10 | Dipping | 29 | 0.129 | 0.165 | Example of the invention |
| 20 | | | | — | — | | Spraying | 30 | 0.128 | 0.166 | Example of the invention |
| 21 | | | | Performed | — | | Dipping | 32 | 0.129 | 0.170 | Example of the invention |
| 22 | | | | Performed | — | | Spraying | 34 | 0.125 | 0.164 | Example of the invention |
| 23 | | | | — | — | 13 | Dipping | 28 | 0.131 | 0.168 | Example of the invention |
| 24 | | | | — | — | | Spraying | 28 | 0.129 | 0.171 | Example of the invention |
| 25 | | | | — | — | 14 | Dipping | 15 | 0.170 | 0.212 | Example of the invention |
| 26 | | | | — | — | | Spraying | 17 | 0.164 | 0.205 | Example of the invention |
| 27 | | | 3.0 | — | — | — | — | 8 | 0.176 | 0.216 | Comparative Example |
| 28 | | | | — | — | 10 | Dipping | 25 | 0.133 | 0.169 | Example of the invention |
| 29 | | | | — | — | | Spraying | 26 | 0.130 | 0.165 | Example of the invention |
| 30 | | | 1.5 | — | — | — | — | 8 | 0.178 | 0.221 | Comparative Example |
| 31 | | | | — | — | 10 | Dipping | 23 | 0.135 | 0.172 | Example of the invention |
| 32 | | | | — | — | | Spraying | 25 | 0.132 | 0.167 | Example of the invention |
| 33 | | Zinc sulfate | 4.9 | — | — | | Dipping | 32 | 0.127 | 0.165 | Example of the invention |
| 34 | | (zinc: 100 g/L) | | — | — | | Spraying | 36 | 0.125 | 0.166 | Example of the invention |
| 35 | GI | Zinc sulfate | 5.7 | — | — | 10 | Dipping | 16 | 0.160 | 0.199 | Example of the invention |
| 36 | | (zinc: 1 g/L) | | — | — | | Spraying | 16 | 0.154 | 0.205 | Example of the invention |
| 37 | | Zinc sulfate | 5.0 | — | — | 6 | Dipping | 15 | 0.167 | 0.204 | Example of the invention |
| 38 | | (zinc: 50 g/L) | | — | — | | Spraying | 17 | 0.153 | 0.196 | Example of the invention |
| 39 | | | | — | — | 10 | Dipping | 26 | 0.133 | 0.170 | Example of the invention |
| 40 | | | | — | — | | Spraying | 28 | 0.130 | 0.165 | Example of the invention |
| 41 | | | | Performed | —- | | Dipping | 30 | 0.128 | 0.166 | Example of the invention |
| 42 | | | | Performed | — | | Spraying | 32 | 0.129 | 0.164 | Example of the invention |
| 43 | | | | — | — | 14 | Dipping | 14 | 0.171 | 0.215 | Example of the invention |
| 44 | | | | — | — | | Spraying | 17 | 0.165 | 0.209 | Example of the invention |
| 45 | EG | Zinc sulfate | 5.7 | — | — | 10 | Dipping | 14 | 0.141 | 0.199 | Example of the invention |
| 46 | | (zinc: 1 g/L) | | — | — | | Spraying | 13 | 0.150 | 0.200 | Example of the invention |
| 47 | | Zinc sulfate | 5.0 | — | — | 6 | Dipping | 16 | 0.142 | 0.192 | Example of the invention |
| 48 | | (zinc: 50 g/L) | | — | — | | Spraying | 18 | 0.139 | 0.191 | Example of the invention |
| 49 | | | | — | — | 10 | Dipping | 23 | 0.135 | 0.170 | Example of the invention |
| 50 | | | | — | — | | Spraying | 26 | 0.136 | 0.169 | Example of the invention |
| 51 | | | | Performed | — | | Dipping | 29 | 0.131 | 0.168 | Example of the invention |
| 52 | | | | Performed | — | | Spraying | 33 | 0.132 | 0.159 | Example of the invention |
| 53 | | | | — | — | 14 | Dipping | 16 | 0.138 | 0.185 | Example of the invention |
| 54 | | | | — | — | | Spraying | 14 | 0.145 | 0.202 | Example of the invention |

*GA: Galvannealing
GI: Hot-dip galvanizing
EG: Electrogalvanizing

Issues below were clarified from the test results shown in Table 1.

Nos. 10 to 13, 15 to 26, 28, 29, and 31 to 54 are examples of the present invention that use aqueous solutions having a zinc ion concentration within the scope of the present invention. Oxide layers with a thickness of 10 nm or more are formed and low coefficients of friction are exhibited. A reduction in coefficient of friction is caused independently of whether a process for contacting a weak alkali aqueous solution is dipping or spraying.

Nos. 28, 29, 31, and 32 are examples of the present invention that use sulfuric acid to reduce the pH of aqueous solutions containing zinc ions. Sufficient oxide layers are formed even at low pH and a reduction in coefficient of friction is verified.

Nos. 21, 22, 41, 42, 51, and 52 are examples in which aqueous solutions containing Zn ions are wiped with rubber rollers prior to the contact with weak alkali aqueous solutions. Oxide layers are formed by the contact with the Zn ion-containing aqueous solutions independently of whether roller wiping is performed or not, resulting in a reduction in coefficient of friction.

No. 1 has a high coefficient of friction because No. 1 is treated with no solution and therefore an oxide layer sufficient to enhance slidability is not formed in a flat portion.

Nos. 2 to 6 are results due to conventional techniques (comparative examples) in which holding was performed for one to 30 seconds after dipping in a treatment solution is finished. Oxide layers grow with the holding time, so that oxide layers with a thickness of 20 nm or more are obtained at a holding time of five seconds or more and oxide layers with a thickness of 30 nm or more are obtained at a holding time of 30 seconds or more.

Nos. 7 to 9 are comparative examples using a Zn-free solution (a sodium acetate solution). Oxide layers have a thickness of less than 10 nm, which is outside the scope of the present invention, and have a high coefficient of friction.

Nos. 14, 27, and 30 are comparative examples performing no treatment with a weak alkali aqueous solution. Sufficient oxide layers are not formed only by the contact with aqueous solutions containing zinc ions and therefore no advantage is obtained.

As is clear from the results of the examples, in Nos. 2 to 6 which are conventional techniques, oxide layers with a thickness of 20 nm or more are not obtained unless holding is performed five seconds or more and oxide layers with a thickness of 30 nm or more are not obtained unless holding is performed 30 seconds or more. In contrast, in the examples of the present invention, the alkali solution-dipping or -spraying time, which corresponds to the holding time taken in each conventional technique, can be significantly reduced to one second. In consideration of production equipment, the present invention is applied to a facility for continuously producing a steel strip at high speed and the rate of producing the steel strip is about 180 m per minute in terms of the movement speed of the steel strip. Therefore, in a conventional technique, the length of a holding facility used subsequently to dipping in a treatment solution needs to be 15 to 90 m; however, in the present invention, only an alkali solution-dipping or -spraying facility with a size of about 3 m at minimum is necessary. This allows a compact facility to be used.

In the techniques disclosed in Patent Documents 3 to 5, in order to secure a sufficient holding time after the contact with an acidic solution under high-speed production conditions, the distance from the contact with an acidic solution to water washing needs to be secured. The test results suggest that good slidability can be achieved by placing a sprayer only subsequently to the contact with an acidic solution containing zinc ions and also suggest that the present invention enables stable production in a reduced space under high-speed conditions.

### INDUSTRIAL APPLICABILITY

A galvanized steel sheet according to the present invention has excellent press formability and therefore can be used for various applications such as automotive bodies. A method for producing a galvanized steel sheet according to the present invention is capable of forming an oxide layer with a desired thickness in a short treatment time. This allows a compact production facility to be used.

1. A method for producing a galvanized steel sheet obtained by forming an oxide layer on a steel sheet, comprising contacting the steel sheet with a zinc-containing aqueous solution having a zinc ion concentration of 1 to 100 g/l, contacting the steel sheet with an aqueous solution with a pH of 6 to 14, washing the steel sheet with water, and then drying the steel sheet.

2. The galvanized steel sheet-producing method according to claim 1, wherein the zinc ion concentration is within a range from 5 to 100 g/l and the aqueous solution has a pH of 7 to 13.

3. The galvanized steel sheet-producing method according to claim 1, wherein the zinc-containing aqueous solution has a pH of 1 to 6.

4. A galvanized steel sheet produced by the galvanized steel sheet-producing method according to claim 1, comprising an oxide layer which principally contains zinc as a metal component, which is disposed on a steel sheet, and which has an average thickness of 10 nm or more.

5. The galvanized steel sheet-producing method according to claim 2, wherein the zinc-containing aqueous solution has a pH of 1 to 6.

6. A galvanized steel sheet produced by the galvanized steel sheet-producing method according to claim 2, comprising an oxide layer which principally contains zinc as a metal component, which is disposed on a steel sheet, and which has an average thickness of 10 nm or more.

7. A galvanized steel sheet produced by the galvanized steel sheet-producing method according to claim 3, comprising an oxide layer which principally contains zinc as a metal component, which is disposed on a steel sheet, and which has an average thickness of 10 nm or more.
